(19) United States
(12) Patent Application Publication
(10) Pub. No.: US 2026/0005365 A1
(43) Pub. Date: Jan. 1, 2026

(54) BATTERY STRUCTURE FOR VEHICLE

(71) Applicant: Mazda Motor Corporation, Hiroshima (JP)

(72) Inventors: Yoshikazu NISHIMURA, Aki-gun, Hiroshima (JP); Taiki YOTSUYANAGI, Aki-gun, Hiroshima (JP); Takamasa INUKAI, Aki-gun, Hiroshima (JP)

(73) Assignee: Mazda Motor Corporation, Hiroshima (JP)

(21) Appl. No.: 19/240,257

(22) Filed: Jun. 17, 2025

(30) Foreign Application Priority Data
Jun. 28, 2024 (JP) 2024-104739

(51) Int. Cl. H01M 50/242; H01M 50/249; H01M 50/264

(52) U.S. Cl. CPC H01M 50/242; H01M 50/249; H01M 50/264; H01M 2220/20

(57) ABSTRACT

A battery structure for a vehicle to protect a battery module against a collision load in a vehicle collision includes a battery module disposed below a floor panel of the vehicle; a battery frame that covers a periphery of a battery module when viewed in a plan view of the vehicle, and that supports the battery module; and a coupling member that couples the battery frame and the battery module to each other, wherein the coupling member includes a deformation promoting part at a position closer to the battery frame than a fixed part that is fixed to the battery module, the deformation promoting part promoting deformation under a collision load that is input to the battery module from the battery frame.

### CROSS-REFERENCE TO RELATED APPLICATION

The present application claims priority to Japanese application number 2024-104739, filed in the Japanese Patent Office on Jun. 28, 2024, the entire contents of which are incorporated herein by reference.

### TECHNICAL FIELD

The present disclosure relates to a battery structure for a vehicle, the battery structure including a battery module disposed below the floor of the vehicle, and a battery frame that covers the periphery of the battery module when viewed in a plan view of the vehicle.

### BACKGROUND

A battery structure that includes a battery-side bracket as described in Patent Literature 1 below, for example, is disclosed as a conventional battery structure for a vehicle that includes a battery frame that covers the periphery of a battery module when viewed in a plan view of the vehicle, and a coupling member that couples the battery frame and the battery module to each other.

The battery-side bracket of Patent Literature 1 is an outer wall body disposed on the outer periphery of a battery pack, which corresponds to the battery module, and the battery-side bracket has a function of protecting the battery pack from an impact load (see paragraphs

to of Patent Literature 1 below, for example).

To be more specific, the battery-side bracket includes a web part and a flange part, the web part corresponding to the battery frame which is formed of an extrusion member having a hollow interior, the flange part corresponding to the coupling member. To allow the flange part to serve as a deformation margin in the event of a vehicle collision, the flange part is provided in such a way as to protrude toward the battery pack from the web part.

Although Patent Literature 1 does not describe a specific form for attaching the flange part to the battery pack, when the flange part is shaped to horizontally protrude toward the battery pack from the web part as shown in FIG. 2 of Patent Literature 1, there is a possibility that the flange part is not sufficiently compressed and deformed in a vehicle collision due to full stretching of the flange part against the side surface of the battery pack, for example.

When this occurs, a collision load is directly input to the battery pack from the web part, which corresponds to the battery frame, via the flange par. Hence, there is room for improvement in enhancing the performance of protecting the battery pack.

According to Patent Literature 1, the web part of the battery-side bracket also serves as a crushable zone in the event of a collision (see paragraph of Patent Literature 1). However, the basic shape of the web part is a closed cross-sectional shape and the web part has high rigidity. Hence, there is also room for improvement in enhancing the performance of protecting the battery pack by efficiently absorbing collision energy.

### CITATION LIST

### Patent Literature

[Patent Literature 1] Japanese Patent Laid-Open No. 2023-6072

### SUMMARY

### Problems to be Solved

The present disclosure has been made in view of such problems, and an object of the present disclosure is to provide a battery structure for a vehicle that is capable of efficiently absorbing collision energy input to the coupling member from the battery frame in a vehicle collision, thus protecting the battery module against a collision load.

### Solutions to the Problems

The present disclosure includes: a battery module disposed below a floor of a vehicle; a battery frame that covers a periphery of the battery module when viewed in a plan view of the vehicle; and a coupling member that couples the battery frame and the battery module to each other, the present disclosure being characterized in that the coupling member includes a deformation promoting part at a position closer to the battery frame than a fixed part that is fixed to the battery module, the deformation promoting part promoting deformation under a collision load that is input to the battery module from the battery frame.

With the above-mentioned configuration, when a collision load is input to the coupling member from the battery frame in a vehicle collision, the deformation promoting part itself or a peripheral portion of the deformation promoting part is deformed, thus efficiently absorbing collision energy. Consequently, an input of the collision load to the battery module from the battery frame is suppressed and it is possible to protect the battery module against the collision load.

As an aspect of the present disclosure, the coupling member may include a bracket having a plate shape and fixed to the battery frame, and a fixing member for fixing the bracket to the battery module at the fixed part.

With the above-mentioned configuration, even when the coupling member is deformed due to a collision load or a collision load is input to the fixed part, for example, it is possible to maintain the bracket and the battery module in a state of being firmly fixed to each other by the fixing member. Accordingly, in the event of a vehicle collision, it is possible to ensure the function of the battery frame to support the battery module via the coupling member.

As an aspect of the present disclosure, the deformation promoting part may include a longitudinal surface part extending in a direction along a side surface part of at least one of the battery module and the battery frame, and a module-side coupling surface part extending from the longitudinal surface part toward the battery module, and a frame-side coupling surface part extending from the longitudinal surface part toward the battery frame, the module-side coupling surface part and the frame-side coupling surface part being disposed at positions different from each other in the direction along the side surface part.

With the above-mentioned configuration, even when a collision load is transmitted to the bracket from the battery frame in a direction along the module-side coupling surface part and the frame-side coupling surface part (also collectively referred to as “coupling surface part”) due to a vehicle collision, flexural deformation (bending deformation) in which the longitudinal surface part falls in a direction along the coupling surface part with a pivot being the boundary part between the longitudinal surface part and the module-side coupling surface part is promoted, so that collision energy can be efficiently absorbed.

As an aspect of the present disclosure, the deformation promoting part may be an opening part formed through a peripheral portion including at least one boundary part of a boundary part between the longitudinal surface part and the module-side coupling surface part and a boundary part between the longitudinal surface part and the frame-side coupling surface part.

With the above-mentioned configuration, the ridge line extending along the boundary part is formed on the bracket. Hence, although the boundary part has a higher strength than other portions, such a boundary part can be divided by the opening part and thus it is possible to weaken the boundary part at which the ridge line is formed.

Accordingly, deformation (bending deformation) of the bracket under a collision load is promoted at the boundary part at which the ridge line is formed and hence it is possible to efficiently absorb collision energy.

As an aspect of the present disclosure, the battery module may include a flange part that is provided in such a way as to protrude toward the longitudinal surface part, and that is fixed to the bracket at the fixed part, and the opening part may be provided at a position that corresponds to the flange part in a direction along the one boundary part.

With the above-mentioned configuration, even when the bracket is deformed in a vehicle collision in a direction in which the longitudinal surface part approaches the flange part provided in such a way as to protrude toward the longitudinal surface part, the flange part is inserted into the opening part provided in the longitudinal surface part. Hence, it is possible to avoid interference between the longitudinal surface part and the flange part.

Accordingly, the bracket can ensure a deformation stroke and sufficiently absorb collision energy.

The present disclosure does not exclude a configuration in which the opening part is provided at a position that does not correspond to the flange part. In addition, in a configuration in which a plurality of opening parts and a plurality of flange parts are provided in a direction along the boundary part, the present disclosure may provide at least one of the opening parts at a position that corresponds to the flange part, or may provide all of the opening parts at positions that do not correspond to the flange parts.

As an aspect of the present disclosure, the bracket may be provided with a coupling surface part extending along a direction in which the battery frame and the battery module are coupled to each other, and the deformation promoting part may include a bead that recesses one of sides of the coupling surface part in an up-down direction (the plate thickness direction of the coupling surface part) by protruding from the other of the sides of the coupling surface part.

With the above-mentioned configuration, the bead acts as a trigger for bending the coupling surface part in a vehicle collision, deformation (bending deformation) of the coupling surface part is promoted and collision energy can be efficiently absorbed.

The bead may have either a shape protruding upward or a shape protruding downward. Furthermore, when a plurality of beads are provided in the coupling surface part, the coupling surface part may include both beads having a shape protruding upward and beads having a shape protruding downward.

As an aspect of the present disclosure, the battery module may include a flange part that is provided in such a way as to protrude toward the battery frame, and that is disposed on the fixed part at the coupling surface part from above, and the bead may protrude downward from a side of the coupling surface part that is opposite in the up-down direction to a side on which the flange part is disposed.

With the above-mentioned configuration, even when the coupling surface part is deformed in such a way as to be collapsed in the coupling direction due to a vehicle collision, it is possible to avoid interference between the bead and the flange part in such a way that they fully stretch against each other. Accordingly, the bracket can ensure a deformation stroke in a vehicle collision, as a result of which it is possible to sufficiently absorb collision energy.

As an aspect of the present disclosure, an end part of the bracket on a side close to the battery module may include a module facing surface part having a surface that faces a surface of a side surface part of the battery module.

With the above-mentioned configuration, even when the end part of the bracket on the side close to the battery module is brought into contact with the side surface part of the battery module in a vehicle collision, the module facing surface part included in the end part is brought into surface contact with the side surface part of the battery module to increase the effect of dispersing the collision load input to the battery module.

The module facing surface part may face the side surface part of the battery module in a state of being in contact with the side surface part of the battery module, or may face the side surface part of the battery module with a space therebetween.

As an aspect of the present disclosure, an end part of the bracket on a side close to the battery frame may include a frame facing surface part having a surface that faces a surface of a side surface part of the battery frame, and the frame facing surface part may be fixed to the side surface part of the battery frame.

With the above-mentioned configuration, the bracket is fixed in a state in which the frame facing surface part is in surface contact with the side surface part of the battery frame and hence it is possible to increase rigidity of supporting the battery module.

### Advantages

According to the present disclosure, it is possible to provide a battery structure for a vehicle that can protect the battery module against a collision load in a vehicle collision.

### BRIEF DESCRIPTION OF DRAWINGS

FIG. 1 is a perspective view of an external appearance of a battery structure for a vehicle in an embodiment as viewed from a point upward and forward of the vehicle.

FIG. 2 is a plan view showing an external appearance of a battery unit with a lid body removed.

FIG. 3 is an enlarged cross-sectional view of a main part taken along arrow line A-A in FIG. 2.

FIG. 4 is an enlarged perspective view showing a main part taken along arrow line A′-A′ in FIG. 2 and as viewed from a point upward and rearward of the main part, some portions of the main part being shown by an imaginary line.

FIG. 5 is an enlarged cross-sectional view of the main part showing the behavior of a coupling member in a vehicle collision in correspondence to FIG. 3.

FIG. 6(a) is an enlarged cross-sectional view of a main part in FIG. 3 showing a first modification of the coupling member shown in FIG. 3.

FIG. 6(b) is an enlarged perspective view of the main part shown in correspondence to FIG. 4 in the same manner.

FIG. 7(a) is an enlarged perspective view of a main part showing a second modification of the coupling member shown in FIG. 3 in correspondence to FIG. 4.

FIG. 7(b) is an enlarged perspective view of a main part of a third modification in the same manner.

### DETAILED DESCRIPTION

Implementations of the present disclosure will be described in detail with reference to the following drawings.

In the drawings, an arrow Y indicates the vehicle body front-rear direction, an arrow W indicates the vehicle width direction, and an arrow Z indicates the up-down direction. Further, an arrow Yf indicates the front side of the vehicle, an arrow Yr indicates the rear side of the vehicle, an arrow Wr indicates the right side of the vehicle, an arrow Wl indicates the left side of the vehicle, an arrow Zu indicates the upper side of the vehicle, and an arrow Zd indicates the lower side of the vehicle. In the description made hereinafter, respective directions, that is, the front direction, the rear direction, the left direction, the right direction, the upward direction, and the downward direction, indicate the respective directions of the vehicle body, that is, the front direction, the rear direction, the left direction, the right direction, the upward direction, and the downward direction of the vehicle body unless otherwise specifically indicated, and the above-mentioned respective directions of the vehicle body are with respect to an occupant seated on the driver's seat.

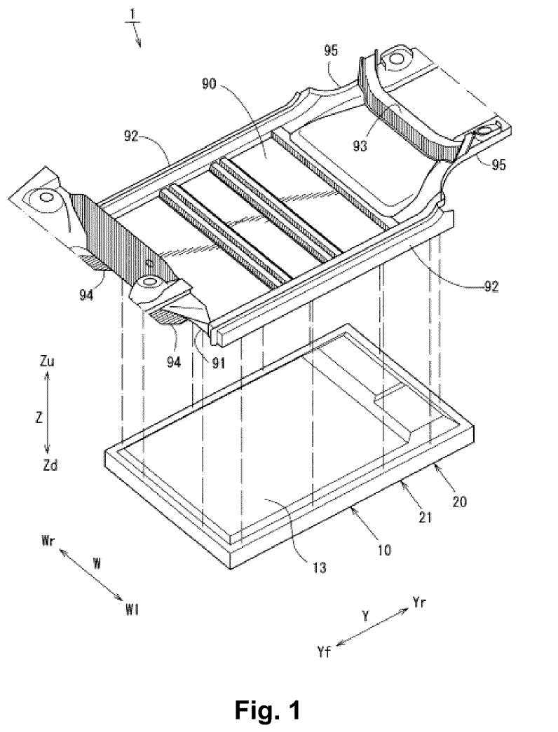

As shown in FIG. 1, a vehicle 1 of is an electric vehicle, such as an electric automobile or a hybrid automobile, for example, that includes at least a motor as a power source. A battery unit 10 that transmits and receives electric power to and from a traveling motor is disposed below a floor panel 90 forming the floor surface of such a vehicle 1.

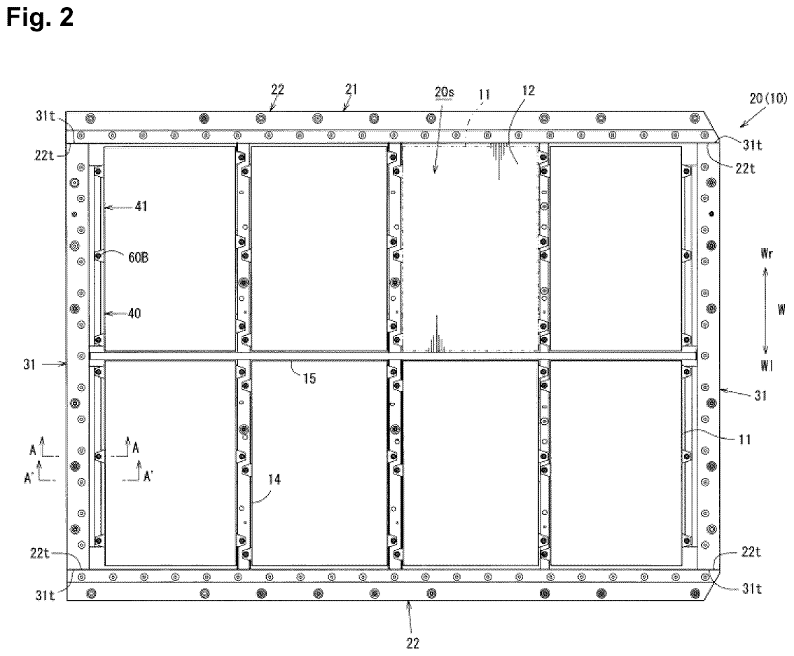

The battery unit 10 includes battery modules 11 (see FIG. 2) and a battery case 20.

Each battery module 11 is a rectangular parallelepiped battery assembly in which a plurality of rectangular parallelepiped battery cells (battery elements) with a specified voltage are arranged in a stack. Although each battery cell is a lithium ion battery, which is a kind of a secondary battery, for example, other kinds of secondary batteries, such asall-solid batteries, may also be adopted.

As shown in FIG. 2, the battery modules 11 described above are housed in the battery case 20. In this example, the battery case 20 has a substantially rectangular shape that is flat in the vehicle up-down direction. By providing the battery case 20 in substantially the whole region below the floor panel 90, it is possible to mount a large capacity battery in the vehicle 1.

As shown in FIG. 1 and FIG. 2, the battery case 20 is made of metal, and includes a battery frame 21, a bottom plate 12 (see FIG. 2), a lid body 13 (see FIG. 1), and coupling members 40 (see FIG. 2). FIG. 2 shows a plan view of the battery case 20 with the lid body 13 removed.

As shown in FIG. 2, the battery frame 21 includes a pair of longitudinal frames 22 and a pair of lateral frames 31, and is formed in a rectangular frame shape with the length in the front-rear direction being longer than the length in the vehicle width direction such that the battery frame 21 can cover the entire periphery of the batteries, that is, the battery modules 11, when viewed in a plan view of the vehicle, and house the battery modules 11. The battery frame 21 supports the battery modules 11 via the coupling members 40 and the like.

The pair of longitudinal frames 22 are disposed on both sides of the battery frame 21 in the vehicle width direction in such a way as to face each other with a space therebetween in the vehicle width direction, and extend linearly along the front-rear direction. The pair of lateral frames 31 are disposed on both sides of the battery frame 21 in the front-rear direction in such a way as to face each other with a space therebetween in the front-rear direction, and extend linearly along the vehicle width direction. The pair of longitudinal frames 22 are formed with the same length, and the pair of lateral frames 31 are formed with the same length. However, the longitudinal frames 22 are formed with a longer length than the lateral frames 31.

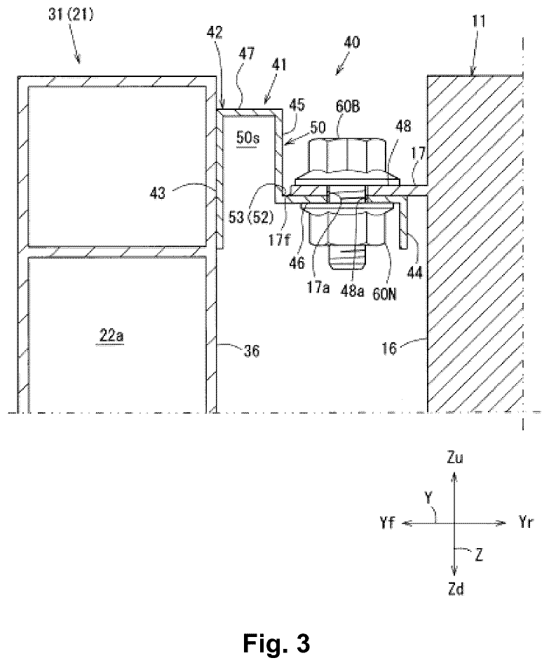

Each longitudinal frame 22 is an extrusion member made of metal, for example, an aluminum alloy and, as shown in FIG. 3, a plurality of closed cross-section portions 22a penetrating through the longitudinal frame 22 in the lengthwise direction (front-rear direction) are formed in the longitudinal frame 22 in parallel to each other. The closed cross-section portions 22a are formed when the longitudinal frame 22 is manufactured by extrusion, and due to such a closed cross-sectional structure, the longitudinal frame 22 has an increased rigidity against a side collision load (a collision load that is input to the vehicle from the lateral side).

The lateral frame 31 is a casting member made of metal, for example, an aluminum alloy. The lateral frame 31 is manufactured from an aluminum alloy casting having a high degree of freedom in shape; thus, it is configured to have a higher torsional rigidity than the longitudinal frame 22 during traveling of the vehicle 1 by providing a plurality of reinforcing ribs, for example, along the up-down direction and the vehicle width direction.

Each of the pair of longitudinal frames 22 has a rectangular shape with the length in the up-down direction being longer than the length in the vehicle width direction, such that an L-shape or an inverted L-shape is formed in an orthogonal cross section orthogonal to the lengthwise direction (front-rear direction). Each of the pair of lateral frames 31 has a rectangular shape with the length in the up-down direction being longer than the length in the front-rear direction in an orthogonal cross section orthogonal to the lengthwise direction (vehicle width direction). All of the pair of longitudinal frames 22 and the pair of lateral frames 31 have the same length (height) in the up-down direction.

As shown in FIG. 2, at each of four corner portions of the battery frame 21 as viewed in a plan view of the vehicle, an end part 22t of the longitudinal frame 22 in the lengthwise direction is fastened, in the lengthwise direction of the lateral frame 31, to a corresponding end part 31t of the lateral frame 31 in the lengthwise direction with a bolt serving as a fastening means. Consequently, the battery frame 21 is formed as an integral piece by the pair of longitudinal frames 22 and the pair of lateral frames 31 in a frame shape when viewed in a plan view.

As shown in FIG. 1, for the battery frame 21 having the above-described configuration, the lateral frame 31 disposed on the front side in a region below the floor of the vehicle 1 is fastened and fixed to left and right torque boxes 91 (only the left side of the vehicle being illustrated). The left and right longitudinal frames 22 are fastened and fixed to corresponding left and right side sills 92. Further, for the battery frame 21, the lateral frame 31 disposed on the rear side of the vehicle is coupled to a floor cross member (also referred to as “No. 4 cross member”) 93.

All of the side sills 92, the torque boxes 91, and the floor cross member 93, which are described above, are vehicle body skeleton members that form the vehicle body skeleton of the vehicle 1. Supplementally, the pair of left and right torque boxes 91 are provided in front of the battery module 11 in such a way as to couple front side frames 94 and the side sills 92 to each other in the vehicle width direction, and each torque box 91 includes a closed cross-section portion extending in the vehicle width direction.

The pair of left and right side sills 92 are provided at the left and right end parts of the floor panel 90, and each side sill 92 includes a closed cross-section portion extending in the vehicle front-rear direction. In addition, the floor cross member 93 includes a closed cross-section portion at the rear end portion of the floor panel 90, the closed cross-section portion extending in the vehicle width direction in such a way as to couple left and right rear side frames 95 to each other in the vehicle width direction.

By fixation of the battery frame 21 described above to the vehicle body skeleton members, the battery modules 11 are supported by the vehicle body via the battery frame 21.

As shown in FIG. 2, the bottom plate 12 covers from below the battery modules 11 housed in the battery case 20 to form the bottom surface part of the battery case 20. The bottom plate 12 extends substantially horizontally to cover the inner (center) region of the battery frame 21 when viewed in a plan view and a region directly below the battery frame 21, the battery frame 21 having a rectangular shape when viewed in a plan view. The bottom plate 12 is fixed to the lower surfaces of the pair of longitudinal frames 22 and the pair of lateral frames 31, which constitute the battery frame 21.

As shown in FIG. 1, the lid body 13 covers from above the battery modules 11 housed in the battery case 20 to form the upper surface part of the battery case 20. The lid body 13 has a region that covers the inner region of the battery frame 21 when viewed in a plan view, and a region directly above the battery frame 21, the battery frame 21 having a rectangular shape when viewed in a plan view. The lid body 13 is fixed to the upper surfaces of the pair of longitudinal frames 22 and the pair of lateral frames 31, which constitute the battery frame 21.

A housing space 20s for the battery modules 11 is defined in the battery case 20 by the battery frame 21 having a rectangular shape when viewed in a plan view, the bottom plate 12, and the lid body 13, which are described above (see FIG. 2).

The bottom plate 12 and the lid body 13 are fixed to the battery frame 21 by fastening bolts in this example. However, this is not a limitation and other fixing means, such as welding, may be adopted.

As shown in FIG. 2, lateral reinforcing members 14 extending in the vehicle width direction and a longitudinal reinforcing member 15 extending in the front-rear direction are disposed as reinforcement members in the battery case 20 (the housing space 20s).

In this example, three lateral reinforcing members 14 are disposed in the housing space 20s, and they are disposed spaced from each other in the front-rear direction in such a way as to divide the housing space 20s substantially equally into four sections in the front-rear direction. Further, each lateral reinforcing member 14 extends over the entire length of the housing space 20s in the vehicle width direction until both end parts of the lateral reinforcing member 14 reach the left and right longitudinal frames 22, and each lateral reinforcing member 14 is erected into a vertical wall shape from the bottom plate 12 to have a height slightly lower than the height of the battery frame 21.

One longitudinal reinforcing member 15 is disposed in the housing space 20s, and it is disposed at an intermediate position of the housing space 20s in the vehicle width direction in such a way as to divide the housing space 20s substantially equally into two sections in the vehicle width direction. Further, the longitudinal reinforcing member 15 extends over the entire length of the housing space 20s in the front-rear direction until both end parts of the longitudinal reinforcing member 15 reach the front and rear lateral frames 31, and the longitudinal reinforcing member 15 is erected into a vertical wall shape from the bottom plate 12 to have a height slightly lower than the height of the battery frame 21.

As shown in FIG. 2, the housing space 20s is divided substantially equally into eight spaces by the lateral reinforcing member 14 and the longitudinal reinforcing member 15 when viewed in a plan view of the vehicle. In each region, the battery module 11 is disposed so as to be in the vicinity of the battery frame 21, the lateral reinforcing member 14, and the longitudinal reinforcing member 15. For example, the side surface of the battery frame 21 on the inner side as viewed in a plan view of the vehicle (inner side surface) faces a side surface part 36 of the lateral frame 31 at a slight gap therebetween, the side surface part 36 directly facing the inner side surface.

As shown in FIG. 2, in this example, the coupling members 40 are disposed in the housing space 20s of the battery frame 21 along the right and left sides of the front and rear lateral frames 31: a total of four coupling members 40 are included in the whole battery case 20. The battery modules 11 disposed in the vicinity of the front and rear lateral frames 31 are supported by the lateral frames 31 via the coupling members 40 disposed between the battery modules 11 and the lateral frames 31.

The four coupling members 40 described above are formed in the same shape as to each other. For this reason, in the following, the specific shape of the coupling members 40 will be described based on the coupling member 40 that is disposed on the front left side when viewed in a plan view of the vehicle, which is shown in a cross-sectional view taken along arrow line A-A in FIG. 2.

Note that the following description will refer to the side surface part 16 of the battery module 11 as a module side surface part 16 and the side surface part 36 of the lateral frame 31 as a frame side surface part 36, out of the side surface parts 16, 36 of the battery module 11 and the lateral frame 31 shown in FIG. 3 that face each other.

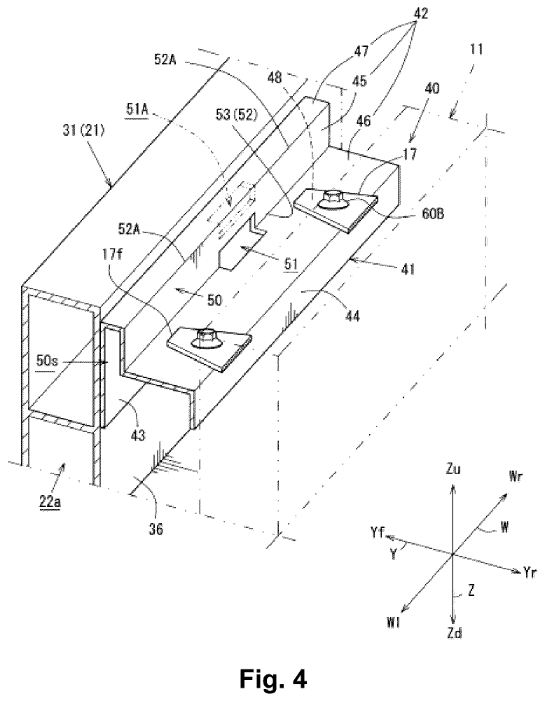

As shown in FIG. 3 and FIG. 4, flange parts 17 are provided in the module side surface part 16 (see FIG. 3) in such a way as to protrude toward the frame side surface part 36 of the lateral frame 31 (that is, toward the front side), the flange parts 17 serving as attaching pieces for attaching the coupling member 40 to the battery module 11. Each flange part 17 is formed in a flat plate shape having a plate thickness in the up-down direction and, as shown in FIG. 3, has a bolt insertion hole 17a that penetrates through the flange part 17 in the plate thickness direction (that is, the up-down direction), the bolt insertion hole 17a allowing insertion of a bolt 60B described later, which is fastened to a bracket 41. As shown in FIG. 2, a plurality of (three in this example) flange parts 17 are provided in each coupling member 40 spaced from each other in the vehicle width direction.

Each coupling member 40 includes the bracket 41 having a plate shape and fixed to the lateral frame 31, and fastening means, the bolts 60B and nuts 60N in this example, that serve as fixing members for fixing the bracket 41 and the battery module 11 to each other.

The bracket 41 as a whole is formed as a plate plastically deformed into the desired shape described later such as by press molding of a metal plate material. The bracket 41 includes a coupling surface part 42, a frame facing surface part 43, and a module facing surface part 44.

Between the frame facing surface part 43 and the module facing surface part 44, the coupling surface part 42 includes a longitudinal surface part 45, a module-side coupling surface part 46, and a frame-side coupling surface part 47 to allow the frame facing surface part 43 and the module facing surface part 44 to be coupled to each other. The longitudinal surface part 45 is formed in a flat plate shape extending along the up-down direction and disposed between the frame facing surface part 43 and the module facing surface part 44.

The frame-side coupling surface part 47 is formed in a flat plate shape that extends from the upper end part of the longitudinal surface part 45 toward the battery frame 21, and the frame-side coupling surface part 47 is formed integrally with the frame facing surface part 43 such that the front end portion of the frame-side coupling surface part 47 is coupled to the frame facing surface part 43.

The module-side coupling surface part 46 is formed in a flat plate shape that extends from the lower end part of the longitudinal surface part 45 toward the battery module 11, and the module-side coupling surface part 46 is formed integrally with the module facing surface part 44 such that the rear end portion of the module-side coupling surface part 46 is coupled to the module facing surface part 44.

Consequently, as shown in FIG. 3, the module-side coupling surface part 46 and the frame-side coupling surface part 47 are disposed at different heights (the frame-side coupling surface part 47 is disposed at a higher position than the module-side coupling surface part 46) in the up-down direction, and are separately disposed on one side (rear side) and the other side (front side) of the longitudinal surface part 45. However, the module-side coupling surface part 46 and the frame-side coupling surface part 47 are coupled to each other via the longitudinal surface part 45, and are formed into a crank shape (stepped shape) as a whole when viewed in a side view of the vehicle.

In this example, the module-side coupling surface part 46 and the frame-side coupling surface part 47 are horizontally disposed so as to be parallel to each other and to have a plate thickness in the up-down direction. The longitudinal surface part 45 is disposed perpendicularly to (to have a right angle with respect to) the module-side coupling surface part 46 and the frame-side coupling surface part 47 when viewed in a side view of the vehicle in such a way as to have a plate thickness in the front-rear direction.

The frame facing surface part 43 is provided at the end part of the bracket 41 on a side close to the battery frame 21 in such a way as to face the frame side surface part 36. More particularly, the frame facing surface part 43 is disposed to extend downward from the end part of the frame-side coupling surface part 47 on the side close to the battery frame 21 along the frame side surface part 36, and to be in surface contact with the frame side surface part 36 from the rear side. In this example, the frame facing surface part 43 is fixed to the frame side surface part 36 by welding.

The frame facing surface part 43 is not limited to being fixed to the frame side surface part 36 by welding, but may be fixed to the frame side surface part 36 by other fixing means, such as fastening by fastening members.

As shown in FIG. 3, the module facing surface part 44 is provided at the end part of the bracket 41 on a side close to the battery module 11 in such a way as to face the module side surface part 16. More particularly, the module facing surface part 44 is disposed to extend downward from the end part of the module-side coupling surface part 46 on the side close to the battery module 11 along the module side surface part 16, and to allow a surface thereof to face the surface of the module side surface part 16 with a space therebetween in the front-rear direction.

In this example, both the frame facing surface part 43 and the module facing surface part 44 are disposed parallel to the longitudinal surface part 45, which has a plate thickness in the front-rear direction and is disposed perpendicularly. The coupling surface part 42, the frame facing surface part 43, and the module facing surface part 44 are formed with the same bracket width (length in the vehicle width direction).

In other words, as shown in FIG. 3 and FIG. 4, a fixed part 48 that is fixed to the flange parts 17 of the battery module 11 is provided at the bracket 41 described above, and the bracket 41 includes a first deformation promoting part 50 and an opening part 51 at positions closer to the battery frame 21 than the fixed part 48, the opening part 51 serving as a second deformation promoting part (see FIG. 4).

The fixed part 48 is a fixed part that is fixed to the flange parts 17 of the battery module 11, and has bolt insertion holes 48a in the module-side coupling surface part 46 extending along the front-rear direction, the bolt insertion holes 48a penetrating through the module-side coupling surface part 46 in the plate thickness direction (that is, the up-down direction).

The fixed part 48 of the module-side coupling surface part 46 of the bracket 41 is fastened and fixed to the flange parts 17 of the battery module 11 by the bolts 60B and the nuts 60N serving as fixing members, the flange parts 17 being disposed on the upper surface of the fixed part 48.

To be more specific, as shown in FIG. 3, with the fixed part 48 of the bracket 41 being fastened to the flange parts 17, bolt insertion holes 17a, 48a which are respectively formed in the flange part 17 and the fixed part 48 are in communication with each other in the up-down direction, the fixed part 48 being disposed on the flange part 17 from below. The bolt 60B is inserted through the bolt insertion holes 17a, 48a, which are caused to communicate with each other as described above, in this order from above. In addition, the nut 60N is screwed to the bolt 60B from below, the bolt 60B protruding downward from the module-side coupling surface part 46. Consequently, the flange parts 17 and the bracket 41 are fastened and fixed to each other in such a way as to be clamped by the bolts 60B and the nuts 60N from both sides.

As shown in FIG. 3, with the fixed part 48 of the bracket 41 being fastened and fixed to the flange parts 17, a distal end 17f (front end) of each flange part 17 and the longitudinal surface part 45, which is located forward of the distal end 17f, are apart from each other in the front-rear direction. The rear end of each nut 60N and the module facing surface part 44, which is located rearward of the rear end, are also apart from each other in the front-rear direction.

As shown in FIG. 4, both the first deformation promoting part 50 and the second deformation promoting part (51) are provided in such a way as to be capable of promoting deformation thereof under a collision load input to the battery module 11 from the battery frame 21, both the first deformation promoting part 50 and the second deformation promoting part (51) being disposed at positions closer to the battery frame 21 than the fixed part 48, which is fixed to the flange parts 17 of the battery module 11.

In this example, the first deformation promoting part 50 is constituted of a portion of the module-side coupling surface part 46 which is located forward of the fixed part 48, the longitudinal surface part 45, and the frame-side coupling surface part 47, the module-side coupling surface part 46 being formed in a crank shape as a whole when viewed in a side view of the vehicle.

Due to the first deformation promoting part 50 provided in the bracket 41 described above, a space 50s is formed at a position forward of the longitudinal surface part 45, the space 50s being defined by the longitudinal surface part 45, the frame-side coupling surface part 47, and the frame facing surface part 43, and being open downward.

As shown in FIG. 4, the second deformation promoting part (51) is the opening part 51 that is formed through a portion spanning from a peripheral portion including a boundary part 52 between the longitudinal surface part 45 and the module-side coupling surface part 46, more particularly, from a portion in the vicinity of the lower end of the longitudinal surface part 45 to a portion in the vicinity of the front end of the module-side coupling surface part 46.

That is, although a ridge line 53 extending along the boundary part 52 is formed at the boundary part 52 between the longitudinal surface part 45 and the module-side coupling surface part 46 to increase the rigidity of the boundary part 52 and a peripheral portion of the boundary part 52, the opening part 51 is provided in such a way as to divide the ridge line 53 in the vehicle width direction.

In this example, a plurality of opening parts 51 are provided along the boundary part 52, and each opening part 51 is provided at a position that does not correspond to (a position that does not match) the flange part 17 in a direction along the boundary part 52 of the bracket 41 (vehicle width direction), more particularly, each opening part 51 is provided at a position between the adjacent flange parts 17 (see FIG. 4).

As shown in FIG. 1 and FIG. 2, the battery unit 10 as the battery structure for the vehicle 1 includes: the battery module 11 disposed below the floor panel 90 of the vehicle; the battery frame 21 that covers the periphery of the battery module 11 when viewed in a plan view of the vehicle, and that supports the battery module 11; and the coupling member 40 that couples the battery frame 21 and the battery module 11 to each other (see FIG. 2) and, as shown in FIG. 3 and FIG. 4, the coupling member 40 includes the first deformation promoting part 50 as a deformation promoting part at a position closer to the battery frame 21 than the fixed part 48 that is fixed to the battery module 11, the first deformation promoting part 50 promoting deformation under a collision load that is input to the battery module 11 from the battery frame 21.

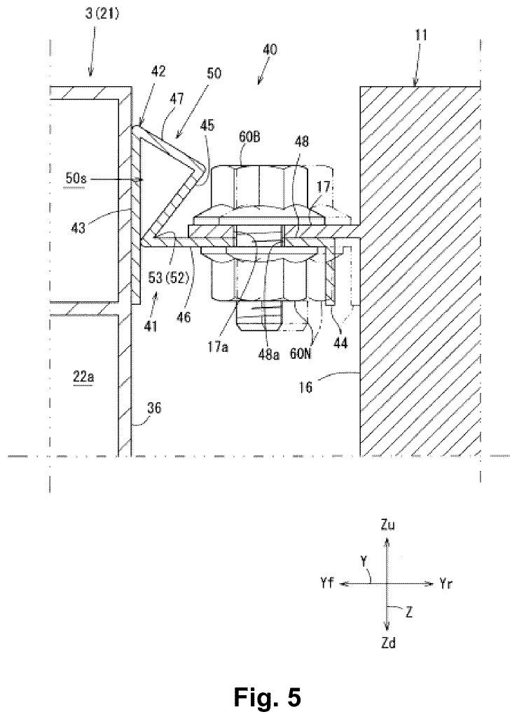

With the above-mentioned configuration, when a collision load is input to the coupling member 40 from the battery frame 21 in a vehicle collision, the battery frame 21 approaches the battery module 11, thus allowing the first deformation promoting part 50 of the coupling member 40 to be deformed in such a way as to be compressed (collapsed) as shown in FIG. 5 for example, thus efficiently absorbing collision energy. Consequently, an input of the collision load to the battery module 11 from the battery frame 21 is suppressed and it is possible to protect the battery module 11 against the collision load.

As an aspect of the present disclosure, as shown in FIG. 3 and FIG. 4, the coupling member 40 includes the bracket 41 having a plate shape and fixed to the battery frame 21, and the bolts 60B and the nuts 60N as a fixing member for fixing the bracket 41 to the battery module 11 at the fixed part 48.

With the above-mentioned configuration, even when the coupling member 40 is deformed due to a collision load or a collision load is input to the fixed part 48, for example, it is possible to maintain the bracket 41 and the battery module 11 in a state of being firmly fixed to each other by the bolts 60B and the nuts 60N. Accordingly, it is possible to enhance the function of the battery frame 21 to support the battery module 11 via the coupling member 40.

As an aspect of the present disclosure, as shown in FIG. 3, the first deformation promoting part 50 is constituted of the longitudinal surface part 45, the module-side coupling surface part 46, and the frame-side coupling surface part 47, the longitudinal surface part 45 extending in the up-down direction along the module side surface part 16 and the frame side surface part 36, the module-side coupling surface part 46 extending horizontally from the longitudinal surface part 45 toward the battery module 11, the frame-side coupling surface part 47 extending horizontally from the longitudinal surface part 45 toward the battery frame 21. The module-side coupling surface part 46 and the frame-side coupling surface part 47 are disposed at different heights in the up-down direction.

With the above-mentioned configuration, due to a collision load transmitted from the battery frame 21 along the frame-side coupling surface part 47 of the bracket 41, a moment load with the pivot being the boundary part 52 between the longitudinal surface part 45 and the module-side coupling surface part 46 acts on the longitudinal surface part 45 as shown in FIG. 5, for example. Hence, flexural deformation (bending deformation) in which the longitudinal surface part 45 laterally falls along the horizontal direction is promoted, as a result of which it is possible to efficiently absorb collision energy.

As an aspect of the present disclosure, as shown in FIG. 4, the deformation promoting part further includes the opening part 51 as a second deformation promoting part that is formed through a peripheral portion including the boundary part 52 between the longitudinal surface part 45 and the frame-side coupling surface part 47.

With the above-mentioned configuration, although the boundary part 52 has a higher strength than other parts because the ridge line 53 extending along the boundary part 52 is formed on the bracket 41, the boundary part 52 can be divided by the opening part 51, and thus it is possible to weaken the boundary part 52 at which the ridge line 53 is formed.

Accordingly, as shown in FIG. 5, deformation (bending deformation) of the bracket 41 under a collision load is promoted at the boundary part 52 at which the ridge line 53 is formed and hence it is possible to efficiently absorb collision energy.

The opening part as the second deformation promoting part is not limited to the opening part 51 (also referred to as “lower opening part 51”) in the this example; as shown by an imaginary line in FIG. 4, the opening part may be an upper opening part 51A (also referred to as “opening part 51A”) that is formed through a peripheral portion including a boundary part 52A between the frame-side coupling surface part 47 and the longitudinal surface part 45. That is, the second deformation promoting part may include at least either one of the upper opening parts 51A and the lower opening parts 51. For example, the second deformation promoting part may include both the upper opening parts 51A and the lower opening parts 51.

As an aspect of the present disclosure, as shown in FIG. 3 and FIG. 4, the end part of the module-side coupling surface part 46 of the bracket 41 on a side close to the battery module 11 includes the module facing surface part 44 having a surface that faces the surface of the module side surface part 16 with a space therebetween.

With the above-mentioned configuration, even if the end part of the bracket 41 on the side close to the battery module 11 is brought into contact with the module side surface part 16 in a vehicle collision such as due to breaking of the fixed part 48, as shown by an imaginary line in FIG. 5, for example, the module facing surface part 44 included in the end part is brought into surface contact with the module side surface part 16. Hence, it is possible to increase the effect of dispersing the collision load that is input to the battery module 11 from the bracket 41.

In a form before a vehicle collision (before deformation of the bracket 41), the module facing surface part 44 in this example faces the module side surface part 16 with a space therebetween in the front-rear direction. However, provided that the module facing surface part of the present disclosure can increase the effect of dispersing the collision load input to the battery module 11 during a vehicle collision by being brought into surface contact with the module side surface part 16, the module facing surface part may face the module side surface part 16 in surface contact with the module side surface part 16 in a form before the vehicle collision.

As an aspect of the present disclosure, as shown in FIG. 3 and FIG. 4, the end part of the bracket 41 on a side close to the battery frame 21 includes the frame facing surface part 43 having a surface that faces the surface of the frame side surface part 36, and the frame facing surface part 43 is fixed to the frame side surface part 36.

With the above-mentioned configuration, the bracket 41 is fixed in a state in which the frame facing surface part 43 is in surface contact with the frame side surface part 36 and hence it is possible to increase rigidity of supporting the battery module 11.

In the correspondence between the components of the present disclosure and the above-described embodiment,
below the floor of the vehicle corresponds to the side below the floor panel 90 of the vehicle and, in the same manner hereinafter,
a deformation promoting part corresponds to at least the first deformation promoting part 50, of the first deformation promoting part 50 and the second deformation promoting part (51),
a fixing member corresponds to the bolts 60B and the nuts 60N, and
an opening part corresponds to the opening part 51 or/and the upper opening part 51A. However, the present disclosure is not only limited to the configuration of the above-described embodiment and many embodiments can be obtained.

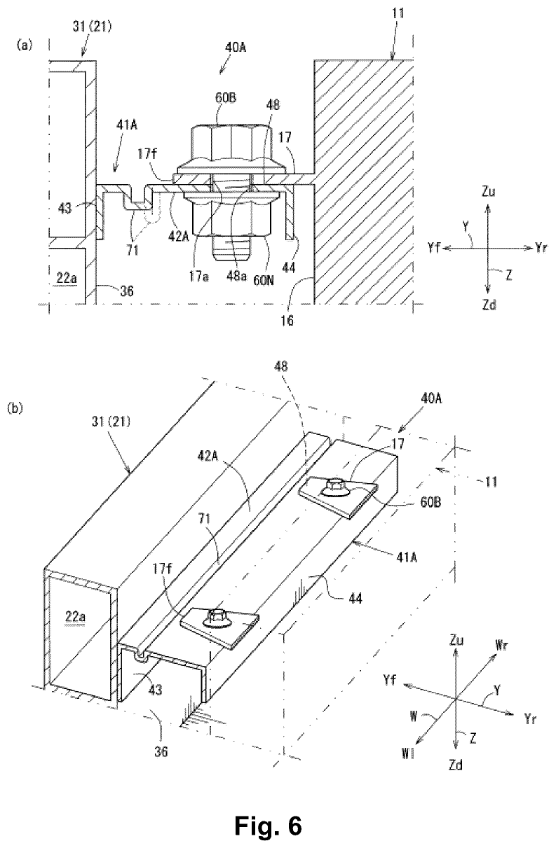

For example, as in the case of a bracket 41A of a modification 1 shown in FIG. 6(a) and FIG. 6(b), the deformation promoting part may include a bead 71 that protrudes downward in such a way as to recess the upper surface of a coupling surface part 42A.

To be more specific, the bracket 41A of the modification 1 does not include the longitudinal surface part 45 at the coupling surface part 42A unlike the embodiment described above, but includes the coupling surface part 42A in which the module-side coupling surface part 46 and the frame-side coupling surface part 47 are continuously formed substantially horizontally. A bead 71 as a deformation promoting part different from the first deformation promoting part 50 described above is provided in such a coupling surface part 42A. The bead 71 in this example is continuously formed over the entire length of the coupling surface part 42A in the vehicle width direction (bracket width direction).

With the above-mentioned configuration, the bead 71 provided in the coupling surface part 42A and protruding downward is collapsed in the front-rear direction in a vehicle collision as shown by an imaginary line in FIG. 6(a), thus acting as a trigger for bending the coupling surface part 42A. Consequently, although the coupling surface part 42A is horizontal along the front-rear direction, there is no possibility of the coupling surface part 42A fully stretching in the front-rear direction in a vehicle collision, and deformation (bending deformation) in which the coupling surface part 42A is compressed in the front-rear direction is promoted, as a result of which it is possible to efficiently absorb collision energy.

Although the bead in the present disclosure may have either a shape protruding upward or a shape protruding downward, it is preferable that the bead protrude from the lower side of the coupling surface part 42A as in the case of the bead 71 of the modification 1 described above, the lower side being the side opposite to the upper side on which the flange parts 17 are disposed.

With such a configuration, it is possible to avoid a situation in which the bead 71 protruding upward is disposed directly forward of the distal end 17f (front end) of the flange part 17. Hence, when the coupling surface part 42A is deformed in such a way as to be collapsed in the coupling direction due to a vehicle collision, it is possible to avoid interference between the flange part 17 and the bead 71 protruding upward. Accordingly, the bracket 41 can ensure a deformation stroke in the vehicle collision, and thus it is possible to sufficiently absorb collision energy.

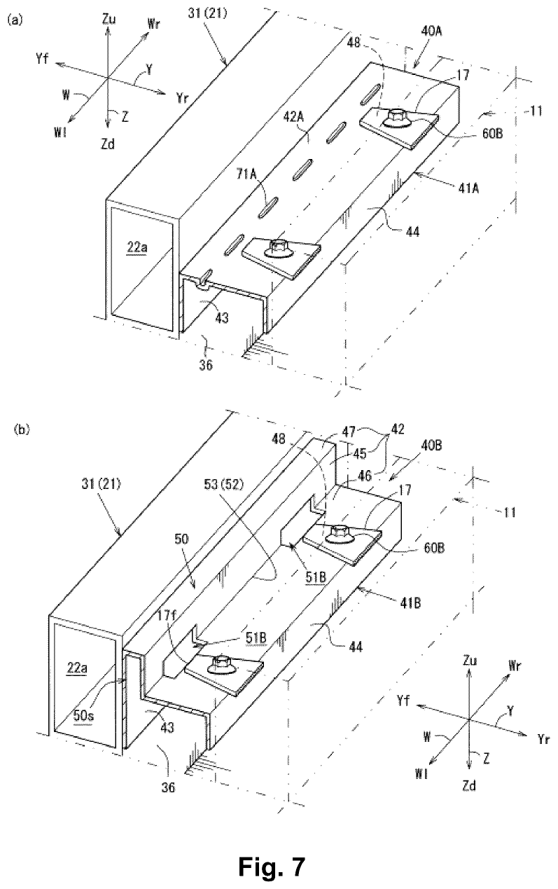

The bead in the present disclosure is not limited to be formed continuously over the entire length in the vehicle width direction as in the case of the bead 71 of the modification 1 described above, and a plurality of beads may be provided at intervals in the vehicle width direction, as in the case of beads 71A shown in FIG. 7(a).

The opening parts as the second deformation promoting part are provided at positions that do not correspond to the flange parts 17 in the direction along the boundary part 52 as in the case of the opening parts 51 of the bracket 41 in the above-described embodiment. However, this is not a limitation; opening parts may be provided at positions that correspond to the flange parts 17, that is, at positions that match the flange parts 17, in the direction along the boundary part 52, as in the case of opening parts 51B of a bracket 41B of the modification 2 shown in FIG. 7(b).

With the above-mentioned configuration, also when due to a vehicle collision, for example, due to breaking of the fixed part 48, compression deformation in the front-rear direction occurs such that the longitudinal surface part 45 of the bracket 41B excessively approaches the flange parts 17 provided in such a way as to protrude toward the longitudinal surface part 45, the flange parts 17 are displaced in such a way as to be inserted into the opening parts 51 provided in the longitudinal surface part 45 and hence, it is possible to suppress interference between the flange parts 17 and the longitudinal surface part 45.

Consequently, there is no possibility that smooth deformation of the bracket 41B is hindered in a vehicle collision due to interference between the longitudinal surface part 45 and the flange part 17 fully stretching in the front-rear direction and it is possible to sufficiently absorb collision energy. That is, it is possible to cause the opening parts 51B to have a function as escape parts that avoid interference between the longitudinal surface part 45 and the flange parts 17 in a vehicle collision, in addition to the function of weakening the boundary part 52 forming the ridge line 53.

In the configuration in which the plurality of flange parts 17 are provided along the vehicle width direction, the plurality of opening parts may be caused to correspond to and match all flange parts 17, or may be displaced not to correspond to the respective flange parts 17 in the direction along the boundary part 52 as described above. Alternatively, opening parts that match the flange parts 17 and opening parts that are displaced from the flange parts 17 may be disposed in a mixed manner.

In the above-described modification 2, the description has been made for the examples in which the first deformation promoting part 50 and the opening parts 51, 51A, 51B as the second deformation promoting parts are provided. However, the present disclosure may have a configuration that does not include the opening parts 51, 51A, 51B serving as the second deformation promoting part, but includes only the first deformation promoting part 50.

Further, the coupling members 40 in the above-described embodiment are provided between the battery modules 11 and the lateral frame 31 in such a way as to be capable of coupling the battery modules 11 and the lateral frame 31 to each other. However, the coupling members in the present disclosure are not limited to such a configuration, and may be provided between the longitudinal frame 22 and the battery modules 11 in such a way as to be capable of coupling the longitudinal frame 22 and the battery modules 11. In such a case, in a side collision of a vehicle, it is possible to efficiently absorb side collision energy by deformation of the deformation promoting parts.

### REFERENCE SIGNS LIST

10 battery unit (battery structure of vehicle)
11 battery module
17 flange part
16 module side surface part (side surface part of battery module)
21 battery frame
36 frame side surface part (side surface part of battery frame)
40, 40A, 40B coupling member
41, 41A, 41B bracket
42, 42A coupling surface part
45 longitudinal surface part
46 module-side coupling surface part
47 frame-side coupling surface part
48 fixed part
50 first deformation promoting part (deformation promoting part)
51, 51A, 51B opening part as second deformation promoting part (deformation promoting part)
52 boundary part between longitudinal surface part and module-side coupling surface part
52A boundary part between longitudinal surface part and frame-side coupling surface part
60B bolt (fixing member)
60N nut (fixing member)
71 bead (deformation promoting part)
90 floor panel
Y front-rear direction (direction in which battery frame and battery module are coupled to each other)
Zu upward direction (direction along the side surface part of at least one of the battery module and the battery frame)

1. A battery structure for a vehicle, the battery structure comprising:
a battery disposed below a floor of the vehicle;
a battery frame that covers a periphery of the battery when viewed in a plan view of the vehicle; and
a coupling member that couples the battery frame and the battery to each other, wherein
the coupling member includes a deformation promoting part at a position closer to the battery frame than a fixed part that is fixed to the battery, the deformation promoting part promoting deformation under a collision load that is input to the battery from the battery frame.

2. The battery structure for a vehicle according to claim 1, wherein
the coupling member includes a bracket having a plate shape and fixed to the battery frame, and a fixing member for fixing the bracket to the battery at the fixed part.

3. The battery structure for a vehicle according to claim 2, wherein
the deformation promoting part includes:
a longitudinal surface part extending in a direction along a side surface part of at least one of the battery and the battery frame; and
a module-side coupling surface part extending from the longitudinal surface part toward the battery, and a frame-side coupling surface part extending from the longitudinal surface part toward the battery frame, the module-side coupling surface part and the frame-side coupling surface part being disposed at positions different from each other in the direction along the side surface part.

4. The battery structure for a vehicle according to claim 3, wherein
the deformation promoting part is an opening part formed through a peripheral portion including at least one boundary part of a boundary part between the longitudinal surface part and the module-side coupling surface part and a boundary part between the longitudinal surface part and the frame-side coupling surface part.

5. The battery structure for a vehicle according to claim 4, wherein
the battery includes a flange part that is provided in such a way as to protrude toward the longitudinal surface part, and that is fixed to the bracket at the fixed part, and
the opening part is provided at a position that corresponds to the flange part in a direction along the one boundary part.

6. The battery structure for a vehicle according to claim 2, wherein
the bracket is provided with a coupling surface part extending along a direction in which the battery frame and the battery are coupled to each other, and
the deformation promoting part includes a bead that recesses one of sides of the coupling surface part in an up-down direction by protruding from the other of the sides of the coupling surface part.

7. The battery structure for a vehicle according to claim 6, wherein
the battery includes a flange part that is provided in such a way as to protrude toward the battery frame, and that is disposed on the fixed part of the coupling surface part from above, and
the bead protrudes downward from a side of the coupling surface part that is opposite in the up-down direction to a side on which the flange part is disposed.

8. The battery structure for a vehicle according to claim 2, wherein
an end part of the bracket on a side close to the battery includes a module facing surface part having a surface that faces a surface of a side surface part of the battery.

9. The battery structure for a vehicle according to claim 2, wherein
an end part of the bracket on a side close to the battery frame includes a frame facing surface part having a surface that faces a surface of a side surface part of the battery frame, the frame facing surface part being fixed to the side surface part of the battery frame.

10. The battery structure for a vehicle according to claim 3, wherein the module-side coupling surface part and the frame-side coupling surface part are disposed at different heights in an up-down direction, forming a crank shape when viewed in a side view of the vehicle.

11. The battery structure for a vehicle according to claim 2, wherein a plurality of coupling members are disposed along sides of the battery frame, and the battery includes a plurality of battery modules supported by the battery frame via the coupling members.

12. The battery structure for a vehicle according to claim 4, wherein a ridge line extending along the boundary part is formed on the bracket, and the opening part divides the ridge line.

13. The battery structure for a vehicle according to claim 3, wherein the deformation promoting part includes a plurality of opening parts formed along the boundary part between the longitudinal surface part and at least one of the module-side coupling surface part and the frame-side coupling surface part.

14. The battery structure for a vehicle according to claim 6, wherein the bead is continuously formed over an entire length of the coupling surface part in a vehicle width direction.

15. The battery structure for a vehicle according to claim 1, wherein the battery frame includes a pair of longitudinal frames extending in a front-rear direction and a pair of lateral frames extending in a vehicle width direction, and the coupling member is disposed between the battery and at least one of the longitudinal frames and the lateral frames.
